(19) United States
(12) Patent Application Publication
(10) Pub. No.: US 2023/0122304 A1
(43) Pub. Date: Apr. 20, 2023

(54) MANUFACTURING EQUIPMENT CONTROL VIA PREDICTIVE SEQUENCE TO SEQUENCE MODELS

(71) Applicant: Liveline Technologies Inc., Livonia, MI (US)

(72) Inventors: Christopher Edward Couch, Ann Arbor, MI (US); John Burtenshaw, Tavistock (CA); Joseph Hernandez, Farmington Hills, MI (US)

(21) Appl. No.: 17/966,121

(22) Filed: Oct. 14, 2022

Related U.S. Application Data
(60) Provisional application No. 63/256,344, filed on Oct. 15, 2021.

(51) Int. Cl. G05B 19/418

(52) U.S. Cl. CPC G05B 19/41885; G05B 2219/32335

(57) ABSTRACT

One or more processors generate a feature set describing evolution of a state space of a manufacturing system from time series data of sensors measuring values of control parameters and exogenous parameters of the manufacturing system, and measuring values of feature parameters of components produced by the manufacturing system. The one or more processors also generate from the feature set predicted values of at least one of the feature parameters, and alter at least one of the control parameters according to the feature set and the predicted values to drive the predicted values toward a target value or target values.

### CROSS-REFERENCE TO RELATED APPLICATION

This application claims the benefit of U.S. provisional application Ser. No. 63/256,344, filed Oct. 15, 2021, the disclosure of which is hereby incorporated in its entirety by reference herein.

### TECHNICAL FIELD

This disclosure relates to the control of manufacturing equipment.

### BACKGROUND

A manufacturing control system may respond to input signals and generate output signals that cause the equipment under control to operate in a particular manner.

### SUMMARY

A manufacturing system includes one or more processors that generate a feature set describing evolution of a state space of the manufacturing system in frequency or time domains from time series data of sensors measuring values of control parameters and exogenous parameters of the manufacturing system, and measuring values of feature parameters of components produced by the manufacturing system. The one or more processors further generate from the feature set and via a sequence to sequence model of the manufacturing system predicted values of at least one of the feature parameters, and alter via a controller agent at least one of the control parameters according to the feature set and the predicted values to drive the predicted values toward a target value or target values.

A method includes generating a feature set describing evolution of a state space of a manufacturing system in frequency or time domains from time series data of sensors measuring values of control parameters and exogenous parameters of the manufacturing system, and measuring values of feature parameters of components produced by the manufacturing system. The method also includes generating from the feature set and via a sequence to sequence model of the manufacturing system predicted values of at least one of the feature parameters, and altering via a controller agent at least one of the control parameters according to the feature set and the predicted values to drive the predicted values toward a target value or target values.

### BRIEF DESCRIPTION OF THE DRAWINGS

FIG. 1 is a block diagram of a manufacturing system.

FIGS. 2 and 3 are block diagrams of a control system.

FIG. 4 is a block diagram of the manufacturing and control systems of FIGS. 1, 2, and 3.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated or described with reference to any one example may be combined with features illustrated or described in one or more other examples to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Sequence to sequence models, and in particular recurrent neural networks, are typically used within the context of natural language processing, such as machine translation, question answering, and text summarization. Here, the sequence to sequence framework is applied to the problem of manufacturing control, with the intent of producing manufactured products having more consistent measurable characteristics, such as stiffness, thickness, length, etc., under circumstances in which a myriad of manufacturing conditions (e.g., temperature, pressure, amperage, etc.) that affect values of these measurable characteristics change over time.

Machinery used in mass production often has control parameters that impact the measurable characteristics of the resulting manufactured components. To illustrate a simple example, a stamping machine may apply a certain amount of pressure for a certain amount time to form metal into a desired shape. The ability of the stamping machine to repeatedly produce the same desired shape thus depends on this pressure and time. If values of these control parameters change over time, a part made an hour earlier may have a slightly different shape than one made an hour later—resulting in less part-to-part consistency.

In this example, the actual pressure applied may be a function of the power supplied to the stamping machine for a given pressure setting. Variability in the power supplied may thus result in variability of the pressure applied even though the pressure setting does not change. Variability in the power supplied may thus be linked to variability in component shape—although with a time lag in between. That is, given the processing times associated with the stamping machine, a change in power supplied at time zero may manifest itself as a deviation from the desired shape at time 42 seconds. If it were possible to predict the impact a sudden change in power supplied would have on component shape, the pressure setting may be strategically altered to offset such changes. Specifically, if a reduction in power is experienced, the pressure setting may be correspondingly increased. If an increase in power is anticipated, the pressure setting may be correspondingly reduced, etc.

Statistical techniques, such as statistical process control, are commonly used to monitor and control manufacturing processes with the goal of producing more specification-conforming products with less waste. Within the context of complex manufacturing processes, these techniques may have a limit as to their effectiveness. Machinery used in mass production may have hundreds, if not thousands, of control parameters (and exogenous parameters) that impact the measurable characteristics of the resulting manufactured components, which may number in the tens (e.g., 20). The ability to predict the impact control parameter and exogenous parameter change has on part measurable characteristics is thus a complex endeavor.

As mentioned above, it has been discovered that machine learning techniques commonly used for natural language processing are well suited for the task of predicting the effect instantaneous changes to numerous parameters may have on component measurable characteristics. These predictions can be used as feedback to control the process to produce more consistent component outcomes even though input (including exogenous) parameters may be changing.

Loosely speaking, recurrent neural networks remember their input via internal memory, making them capable of handling sequential data, such as time series data indicating ambient conditions, control inputs to manufacturing equipment, and measurable characteristics of components produced by the manufacturing equipment. Because of this internal memory, recurrent neural networks can track information about inputs received and predict what is coming next: Recurrent neural networks add the immediate past to the present. As such, recurrent neural networks have two inputs: the present and the recent past. Weights are applied to the current and previous inputs. These weights may be adjusted for gradient descent and backpropagation through time purposes. Moreover, the mapping from inputs to outputs need not be one-to-one.

Long short-term memory networks are an extension of recurrent neural networks. Long short-term memories permit recurrent neural networks to remember inputs over longer periods of time in a so-called memory, that can be read from, written to, and deleted. This memory can decide whether to store or delete information based on the importance assigned to the information. The importance of certain information may be learned by the long short-term memory over time. A typical long short-term memory has sigmoidal input, forget, and output gates. These determine whether to accept new input, delete it, or permit the new input to affect the current timestep output.

Sequence to sequence models can be constructed using recurrent neural networks. A common sequence to sequence architecture is the encoder-decoder architecture, which has two main components: an encoder and a decoder. The encoder and decoder can each be, for example, long short-term memory models. Other such models, such as transformer models, are also contemplated. The encoder reads the input sequence and summarizes the information into internal state or context vectors. Outputs of the encoder are discarded while the internal states are preserved to assist the decoder in making accurate predictions.

The decoder's initial states are initialized to the final states of the encoder. That is, the internal state vector of the final cell of the encoder is input to the first cell of the decoder. With the initial states, the decoder may begin generating the output sequence.

The above and similar concepts have been adapted to be used within the context of manufacturing. Long-short term encoder-decoder models, transformers (e.g., bidirectional encoder representations from transformers, generative pre-trained transformer 3 s, etc.), or other models may form the basis of a sequence to sequence model trained to interpret time series data describing ambient conditions and manufacturing operations, and predict corresponding component characteristics. The time series data may include actual control parameter values (e.g., current, machine revolutions per minute, machine pressure, machine temperature, etc.) and exogenous parameter values (e.g., ambient temperature, humidity, etc.), changes in these values over predefined durations, and other related data, and may be pre-processed using various digital signal processing techniques (e.g., Fourier analysis, wavelet analysis, etc.) to generate a feature set describing evolution of a state space (the set of all possible configurations) of manufacturing equipment in the frequency and/or time domains. For a given application, the specific set of digital signal processing techniques can be determined using standard methodologies including simulation, trial and error, etc.

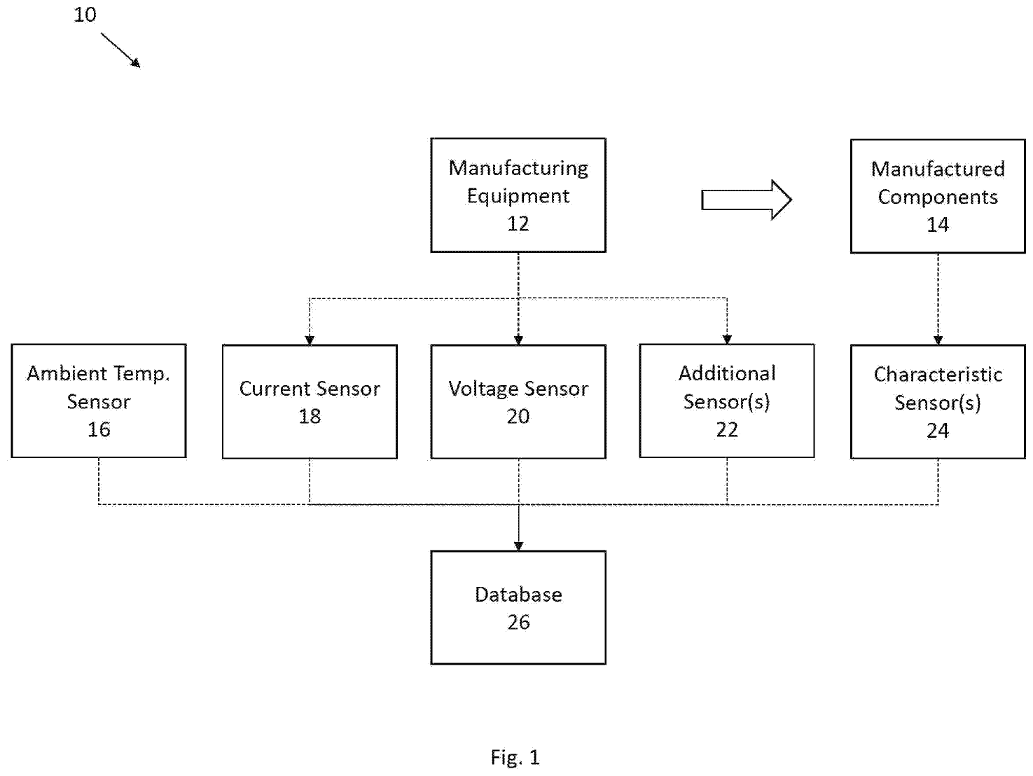

Referring to FIG. 1, a manufacturing system 10 may include manufacturing equipment 12 (e.g., extruders, presses, etc.) that physically or virtually produces (e.g., assembles, creates, etc.) manufactured components 14 (e.g., tubing, panels, etc.). The manufacturing system 10 may also include one or more ambient condition (exogenous) sensors 16, current sensor 18 (e.g., motor drive current sensor, etc.), voltage sensor 20 (e.g., internal temperature sensor, etc.), one or more additional sensors 22 (e.g., conveyor speed sensor, percent proportional-integral-derivate output sensor, etc.), one or more characteristic sensors 24 (e.g., differential pressure sensor, part dimensional sensors, material velocity sensor, etc.), and database 26 (e.g., a relational database, time-series database, etc.). The ambient condition sensors 16 measure one or more ambient conditions (e.g., humidity, temperature, etc.) in a vicinity of the manufacturing equipment 12. The current and voltage sensors 18, 20 measure current and voltage supplied to the manufacturing equipment 12. The additional sensors 22 measure other control parameters of the manufacturing equipment 12. The characteristic sensors 24 measure various feature parameters (e.g., length, stiffness, thickness, etc.) of the manufactured components 14.

These sensed values may be reported to the database 26 sequentially. That is, at time to, each of the sensors 16, 18, 20, 22, 24 detects and reports its value to the database 26, at time ti, each of the sensors 16, 18, 20, 22, 24 detects and reports its value to the database 26, etc. The database 26 thus receives times series data describing ambient condition and control parameter values associated with operation of the manufactured equipment 12, and feature parameter values associated with the manufactured components 14 produced by the manufacturing equipment 12. Such an arrangement can be used to collect a vast amount of data for training purposes.

Various transformations (e.g., data cleansing, band pass filtering, convolutional operations, principal component analysis, wavelet transformation, etc.) on the time series data held in the database 26 can be performed to generate a streaming feature set spanning a relevant state space describing evolution of the manufacturing process associated with the manufacturing equipment 12. In one example, data cleansing includes backfilling, forward filling, and/or null value removing such that the time series data no longer have missing or poor quality entries. After data cleansing, principal component analysis can be performed to maximize the amount of useful information while minimizing the number of features. If the original data set includes pressure, temperature, and drive power all with the same response information, principal component analysis will reduce the size of the data set while maintaining the response information such that, for example, the pressure values are used for continuing transformation and training processes while the temperature and drive power values are ignored. Other transformation operations may, but need not be, further performed. At any point in time, the combined transformed data represents the maximum amount of state information about the manufacturing system 10. The relevant state space can be identified iteratively during model training and evaluation.

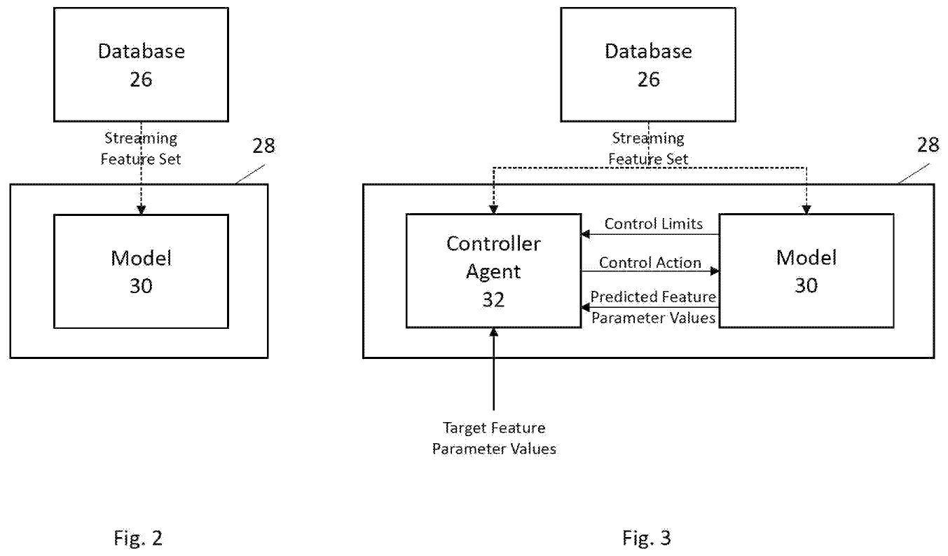

Referring to FIG. 2, one or more processors 28 may implement a long-short term encoder-decoder model 30 (or other appropriate model) trained on at least a portion of the streaming feature set from the database 26. For example, a recurrent neural network linking one machine to another will iterate on model weights until the gradient, representing the change in the model's loss function (e.g., squared error loss, etc.) per change in the model's weights, asymptotically approaches zero. The weights for the recurrent neural network can be seeded randomly. This model can have varying depth and width depending on the number of features present on the specific manufacturing line and the complexity of the dynamic behavior of the manufacturing line. An example model may have two layers with a width of two hundred and fifty six memory units. An adaptive moment estimation (Adam) optimizer can be used to perform the gradient descent with a variable learning rate. Other optimizers, such as Adamax, are also contemplated.

60 minutes, 600 minutes, or 6000 minutes, etc. of the streaming feature set, for example, can be used to train the long-short term encoder-decoder model 30 to recognize the relationships between sensed ambient conditions and control parameter values of the sensors 16, 18, 20, 22 and resulting sensed feature parameter values of the characteristic sensors 24. Once properly trained, the model 30 can predict future feature parameter values of the manufactured components 14 from the streaming feature set.

Referring to FIGS. 1 and 3, the one or more processors 28 may further implement a controller agent 32 trained on the model 30 and the streaming feature set from the database 26. Prior to training of the controller agent 32, the model 30 (or other source) may inform the controller agent 32 as to control limits for the manufacturing equipment 12, which can be simulated by the model 30. Control limits may include, for example, operating pressure ranges for presses (300 psi to 500 psi), operating temperature ranges for drying ovens (50° C. to 80° C.), etc. Moreover, the controller agent 32 may receive target feature parameter values (e.g., target length=3 cm, target stiffness=5 N/m, etc.) for the manufactured components 14. During training of the controller agent 32, the model 30 and controller agent 32 may each synchronously receive a same portion of the streaming feature set from the database 26 to simulate feedback from the sensors 16, 18, 20, 22, 24 during a manufacturing run. This allows the model 30 to generate predicted feature parameter values for simulated manufactured components and to report those to the controller agent 32. The controller agent 32 may then direct control actions to the model 30 to change control settings within the control limits. In a first iteration and assuming an operating pressure of a press simulated by the model 30 is at 310 psi and an operating temperature of a drying oven simulated by the model 30 is 62° C., the controller agent 32 may increase one by some amount and decrease the other by some other amount, and learn what effect such changes have on the predicted feature parameter values from the model 30 relative to the target feature parameter values. The amounts of change may be arbitrary or governed by predetermined rules. The controller agent 32 may perform thousands, if not millions, of such iterations in a relatively short time to train itself on how control settings for the manufacturing equipment 12 can be changed to maintain the predicted feature parameter values, and thus actual feature parameter values, at or near the target feature parameter values as values from the sensors 16, 18, 20, 22, 24 change.

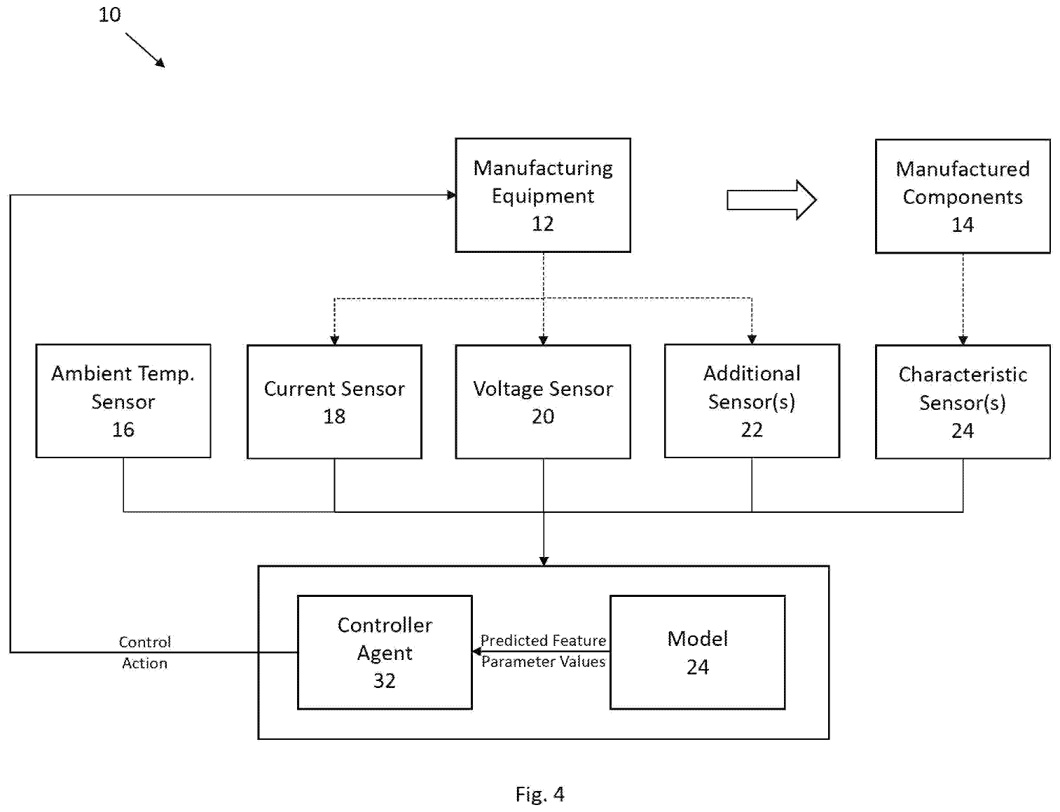

Referring to FIG. 4, once the controller agent 32 is adequately trained (e.g., the error between predicted and target feature parameter values is within some predetermined range such as 5%), the one or more processors 28 may be arranged within the manufacturing system 10 such that they receive live data output by the sensors 16, 18, 20, 22, 24, and pre-process the data using the various transformations mentioned above (e.g., data cleansing and principal component analysis) to generate a live streaming feature seat spanning the relevant state space describing evolution of the manufacturing process associated with the manufacturing equipment 12. Similar to the above, the controller agent 32, now trained, may then direct control actions to the manufacturing equipment 12 to change control settings within their control limits to keep the predicted feature parameter values, and thus actual feature parameter values, at or near the target feature parameter values based on the live streaming feature set and the corresponding predicted feature parameter values.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A manufacturing system comprising:
one or more processors programmed to
generate a feature set describing evolution of a state space of the manufacturing system in frequency or time domains from time series data of sensors measuring values of control parameters and exogenous parameters of the manufacturing system, and measuring values of feature parameters of components produced by the manufacturing system,
generate from the feature set and via a sequence to sequence model of the manufacturing system predicted values of at least one of the feature parameters, and
alter via a controller agent at least one of the control parameters according to the feature set and the predicted values to drive the predicted values toward a target value or target values.

2. The manufacturing system of claim 1, wherein the one or more processors are further programmed to train the sequence to sequence model on past feature sets of the manufacturing system.

3. The manufacturing system of claim 1, wherein the one or more processors are further programmed to train the controller agent on past feature sets and corresponding predicted values from the sequence to sequence model.

4. The manufacturing system of claim 1, wherein the sequence to sequence model is an encoder-decoder model.

5. The manufacturing system of claim 4, wherein the encoder-decoder model includes long short-term memory models.

6. A method comprising:
generating a feature set describing evolution of a state space of a manufacturing system in frequency or time domains from time series data of sensors measuring values of control parameters and exogenous parameters of the manufacturing system, and measuring values of feature parameters of components produced by the manufacturing system,
generating from the feature set and via a sequence to sequence model of the manufacturing system predicted values of at least one of the feature parameters, and
altering via a controller agent at least one of the control parameters according to the feature set and the predicted values to drive the predicted values toward a target value or target values.

7. The method of claim 6 further comprising training the sequence to sequence model on past feature sets of the manufacturing system.

8. The method of claim 6 further comprising training the controller agent on past feature sets and corresponding predicted values from the sequence to sequence model.
